(19) United States
(12) Patent Application Publication
(10) Pub. No.: US 2020/0301553 A1
(43) Pub. Date: Sep. 24, 2020

(54) ESTABLISHING AND USING VIRTUAL ASSETS ON TANGIBLE OBJECTS IN AUGMENTED REALITY (AR) AND VIRTUAL REALITY (VR)

(71) Applicant: Sony Interactive Entertainment Inc., Tokyo (JP)

(72) Inventors: Michael Taylor, San Mateo, CA (US); Glenn Black, San Mateo, CA (US)

(21) Appl. No.: 16/783,070

(22) Filed: Feb. 5, 2020

Related U.S. Application Data
(60) Provisional application No. 62/822,712, filed on Mar. 22, 2019.

(51) Int. Cl. G06F 3/0484; G06F 3/16; G06F 3/0481; G06F 3/0488

(52) U.S. Cl. CPC G06F 3/0484; G06F 3/167; G06F 2203/04804; G06F 3/04883; G06F 3/04812

(57) ABSTRACT

A method includes identifying a tangible object, establishing a virtual overlay on the tangible object in a manner that is visible to a user, detecting the user's interaction with the virtual overlay that is established on the tangible object, and using the user's interaction with the virtual overlay as a basis for input to a processor based system. A system includes a display and a processor based apparatus in communication with the display. A storage medium storing one or more computer programs is also provided.

### CROSS-REFERENCE TO RELATED APPLICATIONS

This application claims the benefit of U.S. Provisional Patent Application No. 62/822,712, filed on Mar. 22, 2019, entitled “ESTABLISHING AND USING VIRTUAL ASSETS ON TANGIBLE OBJECTS IN AUGMENTED REALITY (AR) AND VIRTUAL REALITY (VR)”, the entire contents and disclosure of which is hereby fully incorporated by reference herein in its entirety.

### BACKGROUND OF THE INVENTION

### 1. Field of the Invention

Embodiments of the present invention relate generally to computer enhancement and simulation technology, and more specifically to augmented reality (AR) and virtual reality (VR) technology.

### 2. Discussion of the Related Art

Augmented reality (AR) is an interactive experience of a real-world environment in which the view of reality is modified or augmented by computer-generated information. For example, a live view of the real world as seen by a camera on a smartphone can have computer-generated information, features, and/or elements added to it.

Virtual reality (VR) is a complete immersion interactive computer-generated experience. For example, a VR headset can be used to immerse a user in a fully artificial simulated environment.

Mixed reality (MR) is a mixture of both AR and VR and can be used to create an environment that allows a user to interact with virtual objects in the real world.

### SUMMARY OF THE INVENTION

One embodiment provides a method, comprising: identifying a tangible object; establishing a virtual overlay on the tangible object in a manner that is visible to a user; detecting the user's interaction with the virtual overlay that is established on the tangible object; and using the user's interaction with the virtual overlay as a basis for input to a processor based system.

Another embodiment provides a system, comprising: a display; and a processor based apparatus in communication with the display; wherein the processor based apparatus is configured to execute steps comprising: identifying a tangible object; establishing a virtual overlay on the tangible object in a manner that is visible on the display; detecting a user's interaction with the virtual overlay that is established on the tangible object; and using the user's interaction with the virtual overlay as a basis for input to the processor based apparatus.

Another embodiment provides a non-transitory computer readable storage medium storing one or more computer programs configured to cause a processor based system to execute steps comprising: identifying a tangible object; establishing a virtual overlay on the tangible object in a manner that is visible to a user; detecting the user's interaction with the virtual overlay that is established on the tangible object; and using the user's interaction with the virtual overlay as a basis for input to the processor based system.

A better understanding of the features and advantages of various embodiments of the present invention will be obtained by reference to the following detailed description and accompanying drawings which set forth an illustrative embodiment in which principles of embodiments of the invention are utilized.

### BRIEF DESCRIPTION OF THE DRAWINGS

The above and other aspects, features and advantages of embodiments of the present invention will be more apparent from the following more particular description thereof, presented in conjunction with the following drawings wherein:

FIG. 1 is a diagram illustrating a device viewing a real-world scene in accordance with some embodiments of the present invention;

FIG. 2 is a flow diagram illustrating a method in accordance with some embodiments of the present invention;

FIG. 3 is a diagram illustrating a device viewing a real-world scene in accordance with some embodiments of the present invention;

FIG. 4 is a diagram illustrating a device viewing a real-world scene in accordance with some embodiments of the present invention;

FIG. 5 is a diagram illustrating a device viewing a real-world scene in accordance with some embodiments of the present invention;

FIG. 6 is a flow diagram illustrating a method in accordance with some embodiments of the present invention; and

FIG. 7 is a block diagram illustrating a processor based apparatus/system that may be used to run, implement, and/or execute any of the methods, schemes, and techniques shown and described herein in accordance with the embodiments of the present invention.

### DETAILED DESCRIPTION

Some augmented reality (AR) systems include the ability to generate a virtual user interface (UI) that is included in the real world view. Similarly, some virtual reality (VR) systems include the ability to generate a virtual UI that is included in the virtual world view. However, such UIs suffer from the disadvantage that there is no physical experience because the user is just pushing buttons in the air. For example, if the user has a telephone keypad projected in front of his or her face, pushing buttons in the air is not very satisfying.

Some of the embodiments of the present invention provide methods, systems, and techniques that can be used to improve UIs in AR, VR, and mixed reality (MR) by providing the user with a tangible and physical object that the user can touch and feel when interacting with the UI. Actual tangible and physical objects in the real world are used so the user can hold and feel the actual geometry of the object in his or her hands. It is believed that the ability to touch, hold, and feel a tangible, physical object provides a much more satisfying AR, VR, and MR experience.

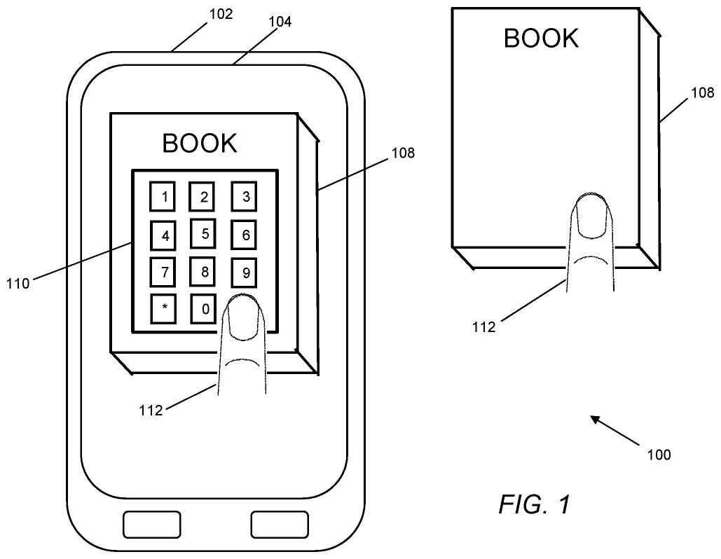

Referring to FIG. 1, there is illustrated a system 100 which is operating in accordance with an embodiment of the present invention. The system 100 includes a smartphone 102 having a display 104 and a camera (not shown) on the backside.

In some embodiments, for example, a user may be operating the smartphone 102 in an AR mode. The user may decide that he or she needs a keypad, such as for entering a telephone number or for entering a password or passcode for gaining access to some type of secure area. So the user grabs any tangible object that may be nearby, such as for example the tangible object 108, which in this example is a book. The book is something that the user can actually hold. The camera on the back of the smartphone 102 captures the view of the real world which includes the tangible object 108. As such, the tangible object 108 is displayed on the display 104 of the smartphone 102.

In some embodiments, the user then provides a verbal command to the system 100 by speaking the word “keypad”. The word “keypad” may comprise a keyword that has a UI associated with it, which in this case is a keypad. In some embodiments, in response to the verbal command, a virtual overlay 110 is then established or projected onto the surface of the tangible object 108 in a manner that is visible to the user by being visible on the display 104. In this example the virtual overlay 110 comprises a UI, and in particular a keypad, which is an asset that can be used for many different types of applications. The establishment of the virtual overlay 110 on the tangible object 108 creates a virtual keypad, which comprises a type of virtual asset. By way of example, the keypad may be used as part of a telephone for the entry of a telephone number, or for entry of a password or passcode as stated above. But it should be well understood that the virtual overlay 110 may comprise any type of UI, feature, or other virtual asset.

With the keypad virtual overlay 110 being established on the surface of the tangible object 108, the user is then able to interact with something tangible such that the user can actually hold and feel a physical object and is not just pushing buttons in the air. For example, as shown the tip of the user's finger 112 is touching the tangible object 108 in the real world. As shown on the display 104, the user's finger 112 is interacting with the virtual overlay 110 that is established on the tangible object 108. In this example, by touching the tangible object 108 and viewing the display 104, the user is able to enter a phone number into the keypad that comprises the virtual overlay 110.

In some embodiments, the processor based system included in the smartphone 100 detects the user's interaction with the virtual overlay 110 that is established on the tangible object 108. In some embodiments, the detection may be performed by tracking the user's finger 112. In some embodiments, the tracking may be performed by using one or more cameras, such as the smartphone camera, or any other image capture or depth sensing devices, to detect an intersection of the user's finger 112 with a geometry of the virtual overlay 110. In some embodiments, the tracking may be performed by using acoustic tracking or sending to listen to the user's finger 112 tap on the tangible object 108.

In some embodiments the user's interaction with the virtual overlay 110 is used as a basis for input to a processor based system, such as the processor based system included in the smartphone 100. For example, the user's interaction with the virtual overlay 110 may be used as a basis for input to an application, program, process, simulation, or the like. In the illustrated example, the user's interaction with the virtual overlay 110 is used to enter a telephone number that is used as input to, for example, the telephone included in the smartphone 102.

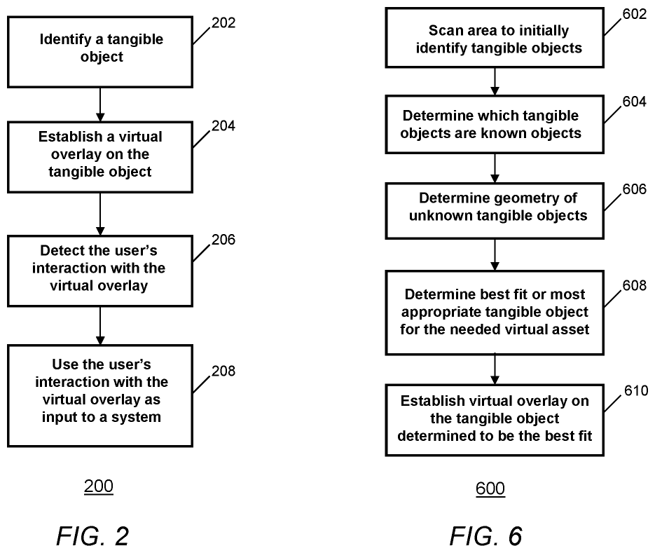

Referring to FIG. 2, there is illustrated a method 200 in accordance with an embodiment of the present invention. In some embodiments the method 200 may be performed by the system 100 (FIG. 1). In some embodiments the method 200 may be performed by any other type of AR, VR, or MR system, such as a system employing a headset, a glasses-type user device, head-mounted display (HMD), or the like.

In step 202 a tangible object is identified. The tangible object may comprise any tangible, physical object in the real world, such as a book as described above, or any other object, such as for example a cup, can, food plate or dish, pad of paper, piece of wood or plastic, rock, brick, table top, floor, wall, cardboard or metal box, etc. In some embodiments, the tangible object may comprise any object on which the user would like a virtual asset, such as a virtual UI or other feature, to appear. In some embodiments, simple props, such as cardboard or plastic props, may be used to provide tangible objects having various shapes and sizes that might be appropriate for virtual UIs or other virtual assets that might be wanted or needed in an AR, VR, or MR experience.

In some embodiments, the tangible object may initially be identified by a user simply grabbing it or picking it up, such as was described above. The object may then be further identified by a processor based system by way of one or more cameras or other image capture devices.

More specifically, in some embodiments part of the step of identifying a tangible object is to also identify or determine the geometry, form factor, size, location, and/or position of the tangible object. One way to make such determinations is for a system to use cameras or other image capture devices or sensors to determine the geometry and size of an object. For example, in some embodiments, depth sensing devices such as depth sensing cameras may be used. Depth cameras, stereo cameras, depth sensors, and the like, may be used to determine the absolute geometry of the object, its size, and how far away the object is from the user. In some embodiments, one or more such cameras and/or sensors may be used and may be located on a user's headset, glasses-type user device, HMD, or elsewhere in an AR, VR, or MR environment or room.

In some embodiments, another way to determine the size, scale, and geometry of a tangible object is to place it in the view of a camera together with an object of known size, scale, and geometry. That is, take an object of known size and scale along with the unknown object, and hold the two objects up together in front of a camera. The system compares the object of known size and scale to the unknown object to determine the size and scale of the unknown object. By way of example, in some embodiments a system learns and remembers a user's hand size and then makes judgements to determine the size of other tangible objects by comparing them to the user's hand.

In some embodiments, another way that is used to identify or determine the geometry and size of the tangible object is for a system to use cameras or other image capture devices to recognize and/or identify known objects that have known geometries and sizes. Once the geometry and size of an object is known, it will be remembered and known within the network. For example, a standard twelve ounce soda can has a known size and geometry and is easily recognized. Once it is known and learned in the network the system can retrieve its dimensions and geometry as part of determining its location and depth relative to the user.

In some embodiments, automatic identification of tangible objects may be used. For example, a system can use cameras or other image capture devices to scan a space, such as an entire room, to identify many different tangible objects. Some of the objects will already be of known size and scale, such as for example a soda can as mentioned above, as well as popular consumer products and devices, such as smartphones, tablet computers, etc. The system can first recognize or identify those objects that have a known size and scale. The known objects are then compared to the unknown objects to determine the size, scale, and geometry of the unknown objects. Thus, in some embodiments, all the objects in a room are sized by scanning everything in the room with a camera and then comparing unknown objects to known objects. In this way a system can use auto identification to pre-scale many or even all of the objects in a room.

Referring again to FIG. 2, in step 204 a virtual overlay is established on the tangible object in a manner that is visible to a user. Establishing a virtual overlay on a tangible object creates a virtual asset. In some embodiments, the virtual overlay may comprise a user interface (UI), which may comprise any type of UI, such as for example a calculator, keyboard, keypad as was described above, etc. The virtual overlay is visible to the user by being visible on the display of a device, such as a smartphone, tablet computer, headset, glasses-type user device, HMD, or the like. By establishing or projecting an interface onto the surface of something the user may have picked up or that is nearby (e.g. a wall), the user is able to interact with a UI that appears to the user to be attached to an object that has a certain form factor and that the user can physically feel. That is, the user can feel the tangible object and the form factor as the user interacts with the virtual UI on the object or other tangible surface.

In some embodiments, the virtual overlay is established on the tangible object in response to a command from the user. By way of example, the command from the user may comprises an audio command, such as a verbal or spoken command. In some embodiments, the command from the user also specifies or determines a configuration or purpose of the virtual overlay. For example, the command from the user may specify that the virtual overlay comprise a specific type of UI, such as any of the UIs mentioned above.

As an example, a user may be using an AR, VR, or MR system and be experiencing an AR, VR, or MR environment. While immersed in that environment the user may pick up something from the real world, such as any type of tangible, physical object, and the user may want that object to be a telephone in the virtual environment. The user says the word “telephone”, and in response to that verbal command the system establishes, by projecting or mapping, a virtual telephone interface onto the surface of the object. The object can be anything, such as a brick, piece of wood, or table top surface. The virtual interface is established onto whatever form factor the object comprises.

In some embodiments, the establishing a virtual overlay on the tangible object comprises scaling the virtual overlay to fit the tangible object. Specifically, as described above a system first detects, identifies, and/or recognizes the tangible object that the user has picked up. As also described above, the system then figures out or determines the size, scale, form factor, and/or geometry of the object. For example, if the object is a box the system determines where the edges are located such as by using depth cameras.

Depending on the size and geometry of the tangible object, the system may have to scale the virtual overlay in order for it to fit the object correctly. For example, if the virtual overlay comprises a type of UI that is larger than the surface of the object, the system may scale the virtual UI to make it smaller in order to fit the object correctly. Or, if the virtual overlay comprises a type of UI that is generally square in shape, and the surface of the object is generally rectangular in shape, the system may scale, such as by reconfiguring, the virtual UI to make it generally rectangular in shape in order to fit the object correctly. And as another example, the system may scale the virtual UI, asset, or other feature to the geometry and size of the tangible object so that it looks and feels correct to the user and there is no awkwardness or disconnect perceived by the user.

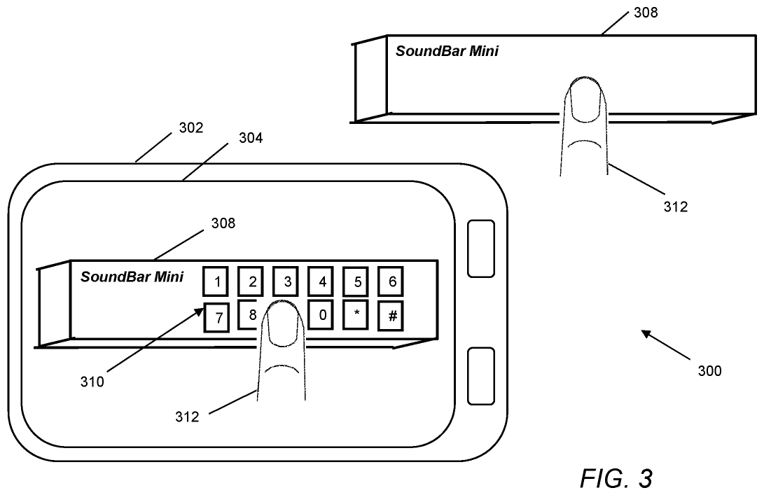

Referring to FIG. 3, there is illustrated an example of scaling a virtual overlay to fit a tangible object in accordance with an embodiment of the present invention. Specifically, there is illustrated a system 300 which is operating in accordance with an embodiment of the present invention. The system 300 includes a smartphone 302 having a display 304 and a camera (not shown) on the backside.

In this example the user is operating the smartphone 302 in an AR mode. Similar to the example discussed above in connection with FIG. 1, the user has decided that he or she needs a keypad, such as for entering a telephone number or for entering a password or passcode for gaining access to some type of secure area. As such, the user has picked up or otherwise obtained the tangible object 308, which in this example just happens to comprise a mini sound bar (a type of consumer electronic device). The camera on the back of the smartphone 302 captures the view of the real world which includes the tangible object 308. As such, the tangible object 308 is displayed on the display 304 of the smartphone 302.

The user would like a keypad UI to be established on a surface of the tangible object 308. Given that the tangible object 308 comprises a sound bar, perhaps the back of the sound bar provides a smoother surface for a keypad. The user can choose whichever surface he or she prefers. In some embodiments, the user then provides a verbal command to the system 300 by speaking the word “keypad”. The word “keypad” may comprise a keyword that has a UI associated with it, which in this case is a keypad. In some embodiments, in response to the verbal command, a virtual overlay 310 is then established or projected onto the surface of the tangible object 308 in a manner that is visible to the user by being visible on the display 304.

Unlike the example discussed above in connection with FIG. 1, however, the surfaces of the tangible object 308 are rectangular in shape instead of being more square like a typical twelve button keypad. As such, in accordance with an embodiment of the present invention, the keypad that comprises the virtual overlay 310 is scaled in order to correctly fit the rectangular surfaces of the tangible object 308. In this example, the scaling comprises reconfiguring the arrangement of the buttons on the keypad so that it includes two rows of six buttons instead of the more typical four rows of three buttons. By scaling the keypad to include two rows of six buttons, the virtual overlay 310 is a much better fit for the rectangular surfaces of the tangible object 308. The scaling may also comprise making the buttons smaller or larger in order to make them all fit on the surface of the tangible object 308. It should be well understood that the virtual overlay 310 may comprise any type of UI or other feature, and that in some embodiments the scaling may comprise increasing or decreasing its size, reconfiguring or rearranging its inputs and/or outputs, modifying or changing its color for a better match, etc.

The establishment of the virtual overlay 310 on the surface of the tangible object 308 creates a virtual keypad, which comprises a type of virtual asset. With the keypad virtual overlay 310 having been scaled and established on the surface of the tangible object 308, the user is able to interact with something tangible such that the user can actually hold and feel a physical object and is not just pushing buttons in the air. As shown the tip of the user's finger 312 is touching the tangible object 308 in the real world. As shown on the display 304, the user's finger 312 is interacting with the virtual overlay 310 that is established on the tangible object 308. By touching the tangible object 308 and viewing the display 304, the user is able to enter a number, such as a phone number, into the keypad that comprises the virtual overlay 310.

In some embodiments, the scaling of the virtual overlay to fit the tangible object may happen automatically during the establishing of the virtual overlay on the tangible object. For example, when the user says the word “keypad”, that verbal command is heard and received by the processor based system included in the smartphone 302. In response to the verbal command or keyword “keypad”, the system begins the process of establishing the virtual overlay 310 on the tangible object 308. As part of that process, the system automatically considers the geometry and size of the tangible object 308 and recognizes that the keypad of the virtual overlay 310 will need to be scaled in order for it to fit on the tangible object 308. As such, the system automatically performs such scaling as part of the process of establishing the virtual overlay 310 on the tangible object 308. With this auto scaling feature, the system can resize, reconfigure, and/or rearrange a virtual UI to fit any size tangible object.

Thus, in some embodiments, a user holds a tangible object, and then says a keyword or command, and in response the system auto scales the virtual overlay (such as a UI) to, or for, the tangible object in order to make it fit the tangible object correctly. The auto scaling feature can be used to automatically make many different types, shapes, and size virtual UIs and other virtual features fit onto the surfaces of many different types, shapes, and size tangible objects. This allows a user to pick up any tangible object to use for a virtual asset because the auto scaling will automatically scale the asset, such as a UI, to fit onto the object.

For example, a user who is experiencing an AR, VR, or MR environment may want a calculator to use in that environment. A standard calculator would generally fit on a book which is rectangular. But if the user picks up a tangible object having square surfaces, the system will automatically scale the virtual calculator interface to fit on the square surfaces of the object. As such, with the auto scaling feature the user has much flexibility in choosing a tangible object for a UI because the system can auto-scale to associate the virtual overlay to any size object.

In some embodiments, in implementing the auto scaling feature, the system uses and considers the geometry, shape, and/or size of the tangible object that, in some embodiments, may be determined during the identifying of the tangible object as described above. The system defines the aspect ratio of the object that is picked up, and then matches the virtual UI to the object by automatically scaling it to fit the object correctly. Furthermore, in some embodiments, as the user moves the tangible object around, the system automatically and continuously rescales the virtual overlay to fit the tangible object in its various different positions so that it continues to look correct as viewed by an AR, VR, or MR device. That is, the system dynamically rescales, such as by resizing or reconfiguring, the virtual overlay in order to continue to fit the tangible object in the real world as it moves around. In some embodiments, it can be said that the system dynamically rescales the virtual overlay in the virtual world to fit the tangible object in the real world. Such dynamic rescaling keeps the virtual overlay properly projected and established on the tangible object as it moves around in the real world. In some embodiments, such dynamically rescaling is implemented by tracking the orientation of the tangible object as it moves, and then rescaling to keep everything oriented correctly so that the virtual overlay, such as a virtual UI, stays on the tangible, real object as it moves.

Thus, in some embodiments, the system automatically scales the virtual asset to the geometry of the tangible object. And in some embodiments, the system automatically continues to dynamically rescale, such as by resizing or reconfiguring, the virtual asset to the geometry of the tangible object.

In some embodiments, the establishing a virtual overlay on the tangible object comprises mapping one or more tangible input mechanisms on the tangible object to one or more virtual input devices on the virtual overlay. Specifically, some of the tangible objects that might be picked up and/or otherwise available to the user include tangible buttons, switches, and/or other input mechanisms. For example, a TV remote control, landline telephone, calculator, garage door opener, automobile key fob, QWERTY keyboard, microwave oven control panel, etc., all include tangible buttons, switches, and/or other input mechanisms. In some embodiments, the system detects that the tangible object has physical buttons and/or switches on it and maps those physical buttons and/or switches to the virtual buttons or other virtual input devices on the virtual asset. The system then detects that the user has pressed one of the tangible buttons on the tangible object and equates that to an activation of the corresponding mapped virtual input device on the virtual asset. This allows the user feel and press a tangible, physical button when interacting with the virtual UI that is displayed on the user's AR or VR display. Furthermore, in this way a tangible, real device, such as a TV remote control, can be made into something else, like a calculator, etc., by mapping the buttons.

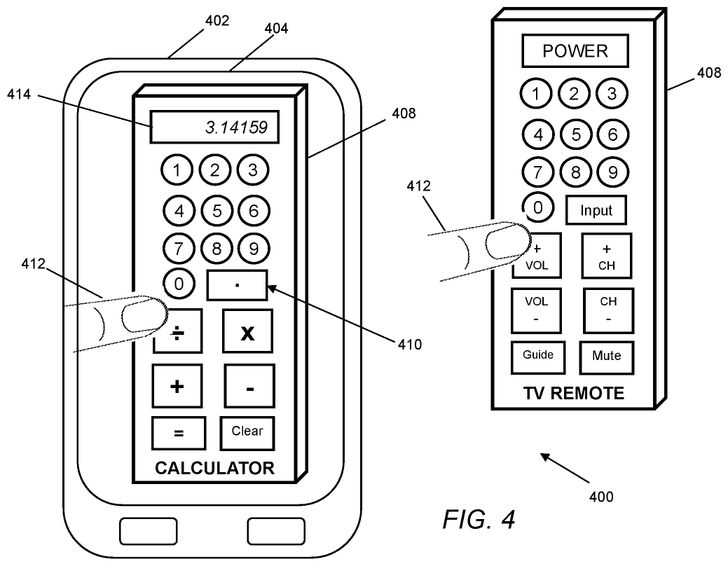

Referring to FIG. 4, there is illustrated an example of mapping tangible input mechanisms to virtual ones in accordance with an embodiment of the present invention. Specifically, there is illustrated a system 400 which is operating in accordance with an embodiment of the present invention. The system 400 includes a smartphone 402 having a display 404 and a camera (not shown) on the backside.

In this example the user is operating the smartphone 402 in an AR mode. The user has decided that he or she needs a calculator to make some calculations involving the number pi (π), which is approximately equal to 3.14159. As such, the user has picked up or otherwise obtained the tangible object 408 in the real world, which in this example comprises a television (TV) remote control. The camera on the back of the smartphone 402 captures the view of the real world which includes the tangible object 408. As such, the tangible object 408 is displayed on the display 404 of the smartphone 402.

The user would like a virtual calculator to be established on the tangible object 408 and displayed on the display 404. As such, in some embodiments, the user provides a verbal command to the system 400 by speaking the word “calculator”. The word “calculator” comprises a keyword that has a calculator UI associated with it. In some embodiments, in response to the verbal command, a virtual overlay 410 is then established or projected onto the surface of the tangible object 408 in a manner that is visible to the user by being visible on the display 404. That is, a virtual calculator, which comprise a type of virtual asset, becomes visible on the display 404.

Because the tangible object 408 comprises a TV remote control, it includes several tangible, physical, and real input buttons. In some embodiments, as part of the process of establishing the virtual overlay 410 on the tangible object 408, the system maps one or more of the tangible, physical, and real input buttons of the TV remote control to the virtual inputs that are displayed on the display 404 and that are needed for the virtual calculator. For example, as shown the following button mappings have been established:

The numerical buttons 1-9 and 0 on the TV REMOTE have been mapped to the numerical buttons 1-9 and 0 on the virtual CALULATOR.

The “Input” button on the TV REMOTE has been mapped to the decimal point (i.e. “.”) button on the virtual CALULATOR.

The “VOL+”, “VOL−”, “CH+”, and “CH−” buttons on the TV REMOTE have been mapped to the “+”, “+”, “×”, and “−” buttons, respectively, on the virtual CALULATOR.

The “Guide” and “Mute” buttons on the TV REMOTE have been mapped to the “=” and “Clear” buttons, respectively, on the virtual CALULATOR.

In addition, in some embodiments, one or more of the tangible, physical, and real input buttons on a tangible object may either be completely eliminated in a virtual overlay, such as by being covered up or masked, or may be replaced by a different asset or feature. For example, as shown the following replacement has been established:

The “POWER” button on the TV REMOTE has been replaced by an output display screen 414 on the virtual CALULATOR.

With the calculator virtual overlay 410 having been established on the tangible object 408, the TV remote control has been made into something else, namely a virtual calculator, by mapping the buttons. Furthermore, the user is able to interact with something tangible such that the user can actually hold and feel a physical object and is not just pushing buttons in the air. As shown, the tip of the user's finger 412 is touching the “VOL+” button on TV remote control in the real world. But as shown on the display 404, the user's finger 412 is touching the “+” button on the virtual calculator that is established on the tangible object 408. By touching the tangible object 408 in the real world and viewing the display 404, the user is able to interact with the virtual calculator that comprises the virtual overlay 410 and that is displayed on the display 404.

Thus, as illustrated, some of the embodiments of the present invention provide for the mapping of buttons and other input mechanisms that are on the tangible, real object to the virtual inputs that are on the virtual asset, such as a virtual interface. In some embodiments, such mapping is performed automatically as part of the establishing of the virtual overlay on the tangible object. For example, in some embodiments the system uses cameras or other image capture devices to identify the button layout of a tangible object. In some embodiments, the system recognizes the tangible object and already knows the layout of its interface, such as its button layout. The system may then make a determination as to whether it can map the button layout of the real, tangible object to the button layout of the virtual asset. That is, the system may make a determination as to whether the layouts are similar enough so as to be mapped. If so, the system proceeds with the mapping. For example, the system recognizes the button layout of something, like a TV remote control, or microwave oven keypad, and the system then maps those physical buttons to the virtual asset, such as a virtual UI. As such, the user can press and interact with the tangible, real, physical buttons and activate something on the virtual asset that is displayed on the user's AR, VR, or MR display.

In scenarios where the tangible object in the real world comprises an electronic device having tangible buttons or other input mechanisms (such as a TV remote control, microwave oven keypad, landline telephone, etc.), it is preferable that the tangible object and any associated devices be powered off and remain powered off while its buttons are being used to control a virtual asset. For example, if the television corresponding to the TV remote control shown in FIG. 4 is powered on while the buttons of the TV remote control are being used to control the virtual calculator displayed on the display 404, the television would be constantly and randomly changing channels and volume as the user presses the buttons to interact with the virtual calculator. Other people near the television could possibly find that annoying.

In some embodiments, as part of identifying or recognizing the button interface layout of a tangible object in the real world, the system also identifies or determines whether the object and any associated devices are powered on or off. If the object is powered on the user may prefer not to interact with it. And if the object is powered off, it is preferable to take steps to prevent the object from being powered on while the user is interacting with it. For example, it is okay to interact with the TV remote control as long as the user does not press the power button for the TV.

In some embodiments, the system disables any power buttons on the tangible object by, for example, not mapping them to anything on the virtual asset and not showing them on the virtual asset. That is, the system does not show the power buttons in the virtual overlay so that the user does not turn on the actual device in the real world. In some embodiments, the system replaces the power button with something in the virtual asset the user will not need to touch. For example, as shown in FIG. 4, the “POWER” button on the TV REMOTE has been replaced by an output display screen 414 on the virtual CALULATOR. That is, the virtual overlay 410 overlays the “POWER” button with the output display screen 414. The output display screen 414 is not something the user needs to touch, and therefore the user will most likely not accidently power on the television.

Therefore, in some embodiments, the system decides to map certain buttons but not other buttons. For example, the power/start button on a microwave oven keypad can be disabled by not mapping it anything on a virtual asset. As such, the user can interact with the timer on the microwave oven, but he or she cannot turn the microwave on because the start/power button is not mapped or shown on the virtual asset. That is, in some embodiments, the system automatically maps the buttons so the user cannot turn on the device in the real world, which avoids the user accidentally powering on the device. When the system maps the buttons it considers that the power or start button should not be mapped and maybe even should be hidden so that the user does not accidentally turn the device on. This can be done, for example, by hiding the power button or not making it look like a button on the virtual asset, which avoids the user pressing the power button. Thus, in some embodiments, the system chooses the button mapping carefully.

Referring again to FIG. 2, in step 206 the user's interaction with the virtual overlay that is established on the tangible object is detected. For example, in this step the system detects the user's interactions with a virtual asset, such as a virtual UI. In some embodiments, the detecting the user's interaction with the virtual overlay comprises detecting an intersection of a part of the user with a geometry of the virtual overlay. By way of example, the user's interaction with the virtual overlay will often be detected by detecting an intersection of the user's finger with a geometry of the virtual overlay. As was discussed above, in some embodiments, the detection may be performed by tracking the user's finger. In some embodiments, the tracking may be performed by using one or more cameras or other image capture or depth sensing devices. The cameras are used to detect an intersection of the user's finger with a geometry of the virtual overlay.

More specifically, in some embodiments, one or more depth cameras are used to determine whether the geometries of the user's finger and the virtual overlay have intersected. The depth camera, or other depth sensing device or sensor, is used to take depth measurements of the user's finger relative to a particular point on the virtual asset, which is used to determine whether the geometries of the two items have intersected. That is, a depth camera is used to determine whether the user's finger has touched the tangible object at a certain location corresponding to an input on the virtual asset, i.e. that their geometries have intersected. In this way the user's interactions with the virtual asset, such as a virtual UI, is detected.

In some embodiments, acoustic sensing or tracking is used to detect the user's interaction with the virtual overlay. That is, the interaction of the user's finger with the virtual overlay may be detected using acoustic sensing or tracking. For example, the system may listen for the user's finger to touch, contact, or tap on the tangible object. Or, the system may listen for the sound a button (or other input mechanism) on the tangible object makes when it is pressed.

For example, an ordinary retractable ballpoint pen includes a button at one end thereof for extending, and then retracting, the ink cartridge. The button makes a distinctive “click” sound when it is pressed. Acoustic sensing can be used to listen for the distinctive click sound. Detection of the click sound indicates that the button has been pressed.

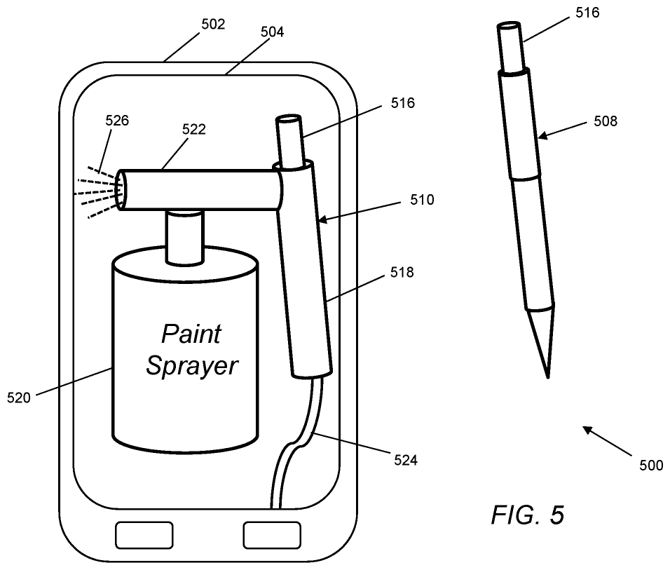

The following example illustrates the use of acoustic sensing in an embodiment of the present invention, as well as several of the other techniques described above. Referring to FIG. 5, there is illustrated another example of establishing a virtual overlay on a tangible object in a manner that is visible to a user, as well as mapping a tangible input mechanisms to a virtual one, all in accordance with an embodiment of the present invention. Specifically, there is illustrated a system 500 which is operating in accordance with an embodiment of the present invention. The system 500 includes a smartphone 502 having a display 504 and a camera (not shown) on the backside.

In this example the user is operating the smartphone 502 in an AR mode. The user has decided that he or she needs a virtual paint sprayer to create some virtual graffiti. As such, the user has picked up or otherwise obtained the tangible object 508 in the real world, which in this example comprises an ordinary retractable ballpoint pen. The pen includes a button 516 at one end thereof for extending, and then retracting, the ink cartridge. As discussed above, the button makes a distinctive “click” sound when it is pressed. The camera on the back of the smartphone 502 captures the view of the real world, which includes the tangible object 508.

The user would like a virtual paint sprayer to be established on the tangible object 508 and displayed on the display 504. As such, in some embodiments, the user provides a verbal command to the system 500 by speaking the words “paint sprayer”, or something similar. Those words comprises a key phrase, and in some embodiments, in response to the verbal command, a virtual overlay 510 is then established or projected onto the tangible object 508 in a manner that is visible to the user by being visible on the display 504. That is, a virtual paint sprayer becomes visible on the display 504.

In this example the virtual overlay 510 that is established on the tangible object 508 is quite elaborate. Namely, the virtual overlay 510 includes an enhanced handle portion 518 that covers all of the ballpoint pen except for the button 516. The virtual overlay 510 also includes a spay nozzle portion 522 that is connected to the handle portion 518, as well as a paint canister 520. A hose 524 is also connected to the handle portion 518. Thus, even though the tangible object 508 is in the view of the camera on the smartphone 502, most of the tangible object 508 is covered by the virtual overlay 510, and therefore, most of the ballpoint pen, except for the button 516, is not visible on the display 504. Instead, what is visible is a virtual paint sprayer that has been overlayed on, projected on, and/or formed around the ballpoint pen (i.e. the tangible object 508).

Thus, a user can grasp the tangible ballpoint pen in his or her grip in the real world, and what appears on the display 504 is the user's hand holding a paint sprayer. By grasping the ballpoint pen in the real world, the user feels like he or she is actually holding the paint sprayer. Of course, the paint sprayer is a virtual asset and does not actually exist in the real world.

As discussed above, the tangible object 508 includes the tangible button 516 with a distinctive “click” sound when it is pressed. The click sound is a clear and distinct sound that makes a good audio or acoustic trigger. In some embodiments, as part of the process of establishing the virtual overlay 510 on the tangible object 508, the system maps the tangible button 516 as the trigger for the virtual paint sprayer. That is, when the tangible button 516 is pressed by the user in the real world, the virtual paint sprayer turns on and appears to be spaying paint, as indicated at 526. This is an example of the physical pen click being mapped to control something in the virtual world.

In some embodiments, acoustic sensing is used to detect the pressing of the tangible button 516 by the user in the real world. Specifically, a microphone, such as the microphone included in the smartphone 502, hears and picks up the click sound made by the button 516. The click sound comprises an audio input or trigger that is identified by the system and then used to control the virtual paint sprayer. In this way the click sound can be used as an audio trigger to register an input into the system. That is, the system hears the acoustic input of the button click and then does something in response thereto, which in the illustrated example is to trigger the virtual paint sprayer. The click sound is so distinct that the system is able to respond with very little delay or latency. As such, the system can make something happen at the right time when the click sound is made.

Acoustic sensing may be used instead of, or in addition to, optical or visual sensing for detecting whether the button 516 has been pressed. For example, in some embodiments, the system uses optical or visual data to track the user's finger, which in this example probably comprises the user's thumb, to determine whether the user's thumb presses the tangible button 516 on the tangible object 508. Such optical or visual tracking was described above, and those techniques may be used in this example as well. In some embodiments, the system also uses acoustic sensing in addition to the visual tracking. That is, the system also uses the audio it hears from the button click in addition to the visual tracking to determine whether the button 516 has been pressed. In such embodiments the system synchronizes the visual tracking input with the acoustic input to make something happen at the correct time so there is no latency between the user's press of the button and something being triggered. For example, the inputs are synchronized to prevent or reduce the chances of an awkward or sloppy delay between the user's press of the button 516 and the virtual paint sprayer being triggered. That is, the system attempts to synchronize the visual flash of the button 516 with the acoustic input to trigger or activate the paint sprayer at the correct time with no delay or sloppiness. In this way acoustic sensing can be used in addition to visually tracking the user's finger, which in this example most likely comprises the user's thumb.

It should be well understood that the virtual paint sprayer is just one example application that can make use of the ballpoint pen and the distinctive click sound of its button. And the ballpoint pen is just one example of a tangible object having an input mechanism that can be sensed by means of acoustic sensing. There are many other types of applications that can use acoustic sensing to detect a user's interaction and with many other types of tangible objects. For example, the sound of the button on a retractable ballpoint pen or some other tangible object can be used, for example, as a virtual buzzer for a game show, a type of virtual detonator, etc. That is, the button can be mapped to those items, and the press of the button can be acoustically sensed from the sound of the button and/or visually sensed by visual tracking.

In some embodiments, a system can use accelerometer data to detect a user's interactions with a tangible object in the real world. Similar to visual and acoustic data, such accelerometer data can be used as the basis for a virtual input to a virtual asset. Therefore, in various embodiments of the present invention a system uses visual data, audio data, accelerometer data, or any combination thereof, to detect that a user has interacted with a tangible object, such as by touching the object in a particular location or by pressing a button, which interactions are then used as the basis for input to a virtual asset.

Referring again to FIG. 2, in step 208 the user's interaction with the virtual overlay is used as a basis for input to a processor based system. The processor based system may include any type of processor based system, including any type of AR, VR, or MR type system, such as a processor based system included in a smartphone, tablet computer, notebook computer, desktop computer, etc. By way of example, the user's interaction with a virtual overlay may be used as a basis for input to an application, program, process, simulation, or the like. In the examples described above, the user's interactions with the various different virtual overlays are used as a basis for input to a virtual paint sprayer application or program, a virtual calculator application or program, and a virtual telephone application or program. It should be understood that the user's interaction with a virtual overlay may be used as a basis for input to any other type of application, program, process, simulation, or the like.

Various embodiments and teachings of the present invention are applicable to AR, VR, and MR. The examples described above were in the context of AR, but it should be well understood that the techniques described herein are also applicable to VR and MR. One difference in VR is that the user typically wears a head mounted display (HMD) that totally immerses the user in the VR environment such that the user cannot see the real world. As such, the is user unable to see any portion of a tangible object as it exists in the real world. That is, in VR the user cannot see the actual physical object. Instead, the items that are seen and viewed by the user in VR are completely virtual. But the user is still able to feel and interact with tangible, real objects in the real world with his or her hands and other body parts. As such, the techniques described herein are still very applicable in the VR context because it is believed a user will find it very satisfying to feel and interact with a tangible, real object in the real world with his or her hands even while viewing a completely virtual world.

Thus, the establishing of a virtual overlay on a tangible object, the scaling, and the auto scaling techniques described above are also applicable in the VR and MR contexts. That is, the establishment of virtual overlays as described above is also applicable to VR and MR. For example, in VR a virtual overlay that is seen by the user is projected onto a tangible object. The user can feel the tangible object with his or her hands, and can see the virtual overlay in the virtual world. It is still advantageous to scale the virtual overlay to correctly fit the tangible object so that there is no disconnect between what the user feels with his or her hands and what the user sees. That is, in VR a user may be able to sense a disconnect between what the user sees in the virtual world and what the user feels on the tangible, physical object if they do not align one to one.

As such, scaling and auto scaling is applicable to both VR and MR. But in some embodiments and scenarios, the scaling does not have to be as precise in VR because the user cannot see the actual object and can only feel it with his or her hands. That is, in VR the system does not have to match the scaling perfectly because the user cannot see the actual object anyway, the user can only feel it. As such, the scaling does not have to be as precise in VR unless the user is trying to push a button on the edge of the tangible object. If the user is trying to push a button on the edge of the tangible object, then the user might notice if the system does not match it perfectly. Again, this is because in AR the user has more of an ability to see the tangible object in the real world, and so if the virtual overlay does not exactly match the tangible object it looks strange. Whereas in VR the user will not see a mismatch and can only feel it with his or her hands.

Similarly, the mapping and auto mapping techniques described above are also applicable in the VR and MR contexts. For example, in VR a user is able to feel and use the buttons or other input mechanisms on a tangle object. As such, they can be mapped to virtual input devices on a virtual asset as described above. Such virtual input devices on a virtual asset can be seen by the user in the virtual world.

As mentioned, one difference between VR and AR is that in VR the user cannot see tangible objects in the real world while immersed in VR. Therefore, it is more difficult for the user to identify, select, and/or simply pick up a tangible object for use as a virtual asset. Therefore, in some embodiments an automatic scanning technique for identifying tangible objects may be used. The technique is particularly useful in VR, but is also applicable to AR and MR.

Referring to FIG. 6, there is illustrated a method 600 in accordance with an embodiment of the present invention. The method 600 provides an example of an automatic scanning technique for identifying tangible objects. The method 600 may be performed by any type of AR, VR, or MR system, such as a system employing a headset, a glasses-type user device, head-mounted display (HMD), or the like. And in some embodiments, the method 600 is performed automatically by such systems.

In step 602 a system uses cameras or other image capture devices to scan an area, such as a room, to initially identify or sense one or more tangible objects in the area. This is helpful in the context of VR because as stated above in VR the user is unable to see the real world. As such, the system uses cameras or the like to initially identify tangible objects that are nearby, such as tangible objects that are in the same physical real world room as the user. Such cameras may be attached to a user's headset, glasses, HDM, smartphone, or the like, or otherwise be positioned in the room.

In step 604, for tangible objects that have been initially identified, the system determines which of the objects are known objects such that they have a known size and geometry. For example, as discussed above, some of the tangible objects will already be of known size and scale, such as for example a soda can, as well as popular consumer products and devices, such as smartphones, tablet computers, etc. These objects are already known to the network. Thus, in this step the system first recognizes or identifies those objects that have a known size and scale.

In step 606, for unknown tangible objects that have been initially identified, the system uses cameras, such as depth cameras, and/or other types of image capture devices or sensors, or comparisons to known objects, to determine the size, scale, and/or geometry of the unknown objects. Examples of these techniques were also discussed above.

In step 608, the system determines which of the identified tangible objects would be the best fit or would otherwise be most appropriate for any requested or needed virtual asset. For example, a user may have requested a certain type of virtual asset by providing a verbal command as described above. Or, the state of a computer program or application that is currently running, such as a computer game or other simulation, may indicate that a certain type of virtual asset will soon be needed. In response to such request or need, the system will consider the size, scale, and geometry of the identified tangible objects and decide or determine which tangible object would be the best fit or would otherwise be most appropriate for the requested or needed virtual asset.

For example, based on all the tangible objects in the room or other space, the system determines that one particular object is the best fit for the particular virtual UI or other virtual asset that is needed or wanted by the user. That is, based on all the tangible objects that are in front of the user or otherwise available to the user, the system determines that one particular object would be most appropriate for the virtual UI or other virtual asset that is needed or wanted by the user.

In step 610, the system selects the tangible object that is determined to be the best fit or otherwise most appropriate for the requested or needed virtual asset, and then proceeds to establish the needed virtual overlay on that selected tangible object. In this way, in some embodiments, the establishing of a virtual overlay on a tangible object is performed in response to a determination that the tangible object is appropriate for the virtual overlay. Furthermore, in some embodiments, the identifying of a tangible object comprises selecting the tangible object from among two or more tangible objects based on a determination that the tangible object is a best fit for the virtual overlay.

With the needed virtual overlay having been established on the selected tangible object, the requested or needed virtual asset has been created. For example, the selected tangible object has become the needed or wanted virtual asset by overlaying the needed UI or the like on it. The virtual asset may comprise any type of virtual asset, such as virtual UI or any other type of feature. A few examples of such virtual assets include the above described virtual keypad, virtual calculator, and virtual paint sprayer, but any other type of virtual asset may be created using the teachings and techniques described herein.

In some embodiments, the newly created virtual asset will be visible to the user, and therefore, the user will be able to pick it up and use it. Namely, the virtual asset exists within the virtual world, and so even if the user is in a VR environment he or she will be able to see it. The user will be able to pick it up because the virtual asset comprises the tangible object having a virtual overlay. For example, when a user sees the virtual paint sprayer shown in FIG. 5, he or she will be able to reach out and grab the handle 518, which comprises a virtual overlay on the tangible ballpoint pen 508.

As an example of the method 600 (FIG. 6), a user may be using an AR, VR, or MR system. A requested or needed virtual asset may be a sword. The system automatically scans the room or other space to identify tangible objects. One of the identified tangible objects is a magic marker, and the system determines that it is the best fit for a virtual sword. That is, the system sees a magic marker, and the system decides that it would make a great sword. The system then establishes a virtual overlay on the magic marker to make it look like a sword when viewed by the user on the AR, VR, and MR display. The system may make the magic marker be the handle, and the blade of the sword be purely virtual.

Thus, the tangible, real magic marker in the room becomes the sword that the user either wants or will need. When the user looks down in either the AR, VR, or MR environment, he or she sees a sword instead of a magic marker, because the system put a sword overlay on the magic marker. And because the handle of the sword comprises the tangible magic marker, the user is able to grab the handle to pick up of the sword and actually feel the handle of the sword in his or her hand. And as the user moves the sword around, the system will use the tracking and scaling described above to maintain and keep the purely virtual blade of the sword connected to the handle. That is, the system will keep the virtual overlay synchronized with the tangible magic marker in the user's hand, so that the virtual overlay stays with the tangible magic marker.

In some embodiments, the methods, schemes, and techniques described herein may be utilized, implemented and/or run on many different types of processor based apparatuses or systems. For example, the methods, schemes, and techniques described herein may be utilized, implemented, and/or run in any type of AR, VR, and MR system, and any such system may be implemented on smartphones, game consoles, entertainment systems, portable devices, mobile devices, pad-like devices, computers, workstations, desktop computers, notebook computers, servers, etc. Furthermore, in some embodiments the methods, schemes, and techniques described herein may be utilized, implemented and/or run in online scenarios, networked scenarios, over the Internet, etc.

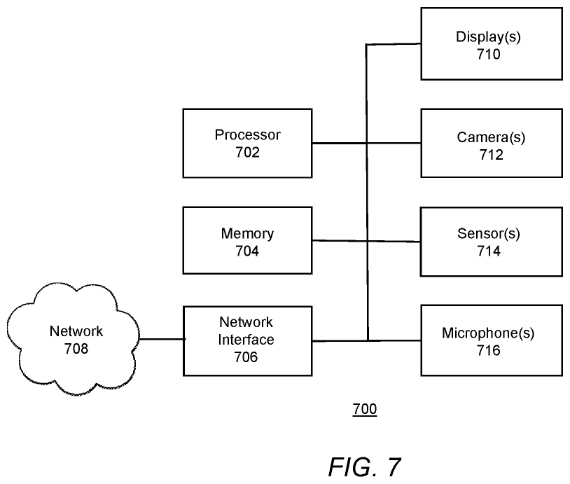

Referring to FIG. 7, there is illustrated an example of a processor based system 700 that may be used for any such implementations. The system 700 may be used for implementing any method, scheme, technique, system, or device mentioned above. However, the use of the system 700 or any portion thereof is certainly not required.

By way of example, the processor based system 700 may include, but is not required to include, a processor 702 (e.g. a central processing unit (CPU)), a memory 704, a wireless and/or wired network interface 706, access to a network 708, one or more displays 710, one or more cameras or other image capture devices 712, one or more sensors 714 (discussed below), and one or more microphones 716. One or more of these components may be collected together in one apparatus, device, or system, or the various components may be distributed across one or more different apparatuses, devices, or systems, or even distributed across one or more networks. The processor 702 may be used to execute or assist in executing the steps of the methods, schemes, and techniques described herein, and various program content, images, video, overlays, UIs, assets, virtual worlds, menus, menu screens, interfaces, graphical user interfaces (GUIs), windows, tables, graphics, avatars, characters, players, video games, simulations, etc., may be rendered on the display(s) 710.

The one or more displays 710 may comprises any type of display devices and may be used for implementing the above described AR, VR, and/or MR environments. For example, in some embodiments a display may be included in a device such as a smartphone, tablet computer, pad-like computer, notebook computer, etc. In some embodiments one or more displays may be associated with any type of computer such as desktop computers, etc. In some embodiments one or more displays may be included in a head worn device such as a headset, glasses-type user device, head-mounted display (HMD), or the like. In some embodiments the one or more displays may be included or associated with any type of AR device, VR device, or MR device. The one or more displays may comprise any type of display or display device or apparatus, using any type of display technology.

The one or more cameras or other image capture devices 712 may comprise any type of cameras or image capture devices. In some embodiments, the one or more cameras may be used for identifying, recognizing, and/or determining the geometry, form factor, size, location, and/or position of tangible objects, and/or for detecting intersections of various geometries, as discussed above. In some embodiments, the one or more cameras may comprise depth cameras, depth sensing cameras, stereo cameras, or any other type of camera or image capture device. In some embodiments, the one or more cameras may be located or positioned on a user's headset, glasses-type user device, HMD, or elsewhere in an AR, VR, or MR environment or room. In some embodiments, the one or more cameras may be included or associated with a device such as a smartphone, tablet computer, pad-like computer, notebook computer, desktop computer, etc.

In some embodiments, if needed or wanted, the one or more sensors 714 may comprise any type of sensor that can be used for identifying, recognizing, and/or determining the geometry, shape, form factor, size, location, and/or position of tangible objects, and/or for detecting intersections of various geometries, as discussed above. In some embodiments, the one or more sensors may comprise depth sensors, infrared sensors, acoustic sensors, accelerometers, or any other type of sensor. In some embodiments, the one or more sensors may comprise any type of sensors for sensing and/or tracking the movements and/or motions of a user and/or a tangible object.

The one or more microphones 716 may comprise any type of microphones. In some embodiments, the one or more microphones may be used for implementing the acoustic sensing and/or acoustic tracking discussed above. In some embodiments, the one or more microphones may be located or positioned on a user's headset, glasses-type user device, HMD, or elsewhere in an AR, VR, or MR environment or room. In some embodiments, the one or more microphones may be included or associated with a device such as a smartphone, tablet computer, pad-like computer, notebook computer, desktop computer, etc.

In some embodiments, the wireless and/or wired network interface 706 may be used for accessing the network 708 for obtaining any type of information, such as for example information regarding known and/or previously learned tangible objects, such as information regarding the geometry, shape, form factor, size, etc., of such tangible objects. The network 708 may comprise the Internet, a local area network, an intranet, a wide area network, or any other network.

The memory 704 may include or comprise any type of computer readable storage or recording medium or media. In some embodiments, the memory 704 may include or comprise a tangible, physical memory. In some embodiments, the memory 704 may be used for storing program or computer code or macros that implements the methods and techniques described herein, such as program code for running the methods, schemes, and techniques described herein. In some embodiments, the memory 704 may serve as a tangible non-transitory computer readable storage medium for storing or embodying one or more computer programs or software applications for causing a processor based apparatus or system to execute or perform the steps of any of the methods, code, schemes, and/or techniques described herein. Furthermore, in some embodiments, the memory 704 may be used for storing any needed database(s).

In some embodiments, one or more of the embodiments, methods, approaches, schemes, and/or techniques described above may be implemented in one or more computer programs or software applications executable by a processor based apparatus or system. By way of example, such processor based system may comprise a smartphone, tablet computer, AR, VR, or MR system, entertainment system, game console, mobile device, computer, workstation, desktop computer, notebook computer, server, graphics workstation, client, portable device, pad-like device, etc. Such computer program(s) or software may be used for executing various steps and/or features of the above-described methods, schemes, and/or techniques. That is, the computer program(s) or software may be adapted or configured to cause or configure a processor based apparatus or system to execute and achieve the functions described herein. For example, such computer program(s) or software may be used for implementing any embodiment of the above-described methods, steps, techniques, schemes, or features. As another example, such computer program(s) or software may be used for implementing any type of tool or similar utility that uses any one or more of the above described embodiments, methods, approaches, schemes, and/or techniques. In some embodiments, one or more such computer programs or software may comprise an AR, VR, or MR application, a tool, utility, application, computer simulation, computer game, video game, role-playing game (RPG), other computer simulation, or system software such as an operating system, BIOS, macro, or other utility. In some embodiments, program code macros, modules, loops, subroutines, calls, etc., within or without the computer program(s) may be used for executing various steps and/or features of the above-described methods, schemes and/or techniques. In some embodiments, such computer program(s) or software may be stored or embodied in a non-transitory computer readable storage or recording medium or media, such as a tangible computer readable storage or recording medium or media. In some embodiments, such computer program(s) or software may be stored or embodied in transitory computer readable storage or recording medium or media, such as in one or more transitory forms of signal transmission (for example, a propagating electrical or electromagnetic signal).

Therefore, in some embodiments the present invention provides a computer program product comprising a medium for embodying a computer program for input to a computer and a computer program embodied in the medium for causing the computer to perform or execute steps comprising any one or more of the steps involved in any one or more of the embodiments, methods, approaches, schemes, and/or techniques described herein. For example, in some embodiments the present invention provides one or more non-transitory computer readable storage mediums storing one or more computer programs adapted or configured to cause a processor based apparatus or system to execute steps comprising: identifying a tangible object; establishing a virtual overlay on the tangible object in a manner that is visible to a user; detecting the user's interaction with the virtual overlay that is established on the tangible object; and using the user's interaction with the virtual overlay as a basis for input to the processor based system.

While the invention herein disclosed has been described by means of specific embodiments and applications thereof, numerous modifications and variations could be made thereto by those skilled in the art without departing from the scope of the invention set forth in the claims.

What is claimed is:

1. A method, comprising:
identifying a tangible object;
establishing a virtual overlay on the tangible object in a manner that is visible to a user;
detecting the user's interaction with the virtual overlay that is established on the tangible object; and
using the user's interaction with the virtual overlay as a basis for input to a processor based system.

2. The method of claim 1, wherein the establishing a virtual overlay on the tangible object comprises automatically scaling the virtual overlay to fit the tangible object.

3. The method of claim 1, wherein the establishing a virtual overlay on the tangible object is performed in response to a command from the user.

4. The method of claim 3, wherein the command from the user comprises an audio command.

5. The method of claim 3, wherein the command from the user determines a configuration of the virtual overlay.

6. The method of claim 1, wherein the establishing a virtual overlay on the tangible object is performed in response to a determination that the tangible object is appropriate for the virtual overlay.

7. The method of claim 1, wherein the virtual overlay comprises a virtual user interface.

8. The method of claim 7, wherein the establishing a virtual overlay on the tangible object comprises mapping one or more tangible input mechanisms on the tangible object to one or more virtual input devices on the virtual user interface.

9. The method of claim 1, wherein the identifying a tangible object comprises identifying the tangible object with one or more image capture devices.

10. The method of claim 1, wherein the identifying a tangible object comprises identifying a geometry of the tangible object.

11. The method of claim 1, wherein the identifying a tangible object comprises selecting the tangible object from among two or more tangible objects based on a determination that the tangible object is a best fit for the virtual overlay.

12. The method of claim 1, wherein the detecting the user's interaction with the virtual overlay comprises detecting an intersection of a part of the user with a geometry of the virtual overlay.

13. The method of claim 1, wherein the detecting the user's interaction with the virtual overlay comprises acoustic sensing.

14. A system, comprising:
a display; and
a processor based apparatus in communication with the display;
wherein the processor based apparatus is configured to execute steps comprising:
identifying a tangible object;
establishing a virtual overlay on the tangible object in a manner that is visible on the display;
detecting a user's interaction with the virtual overlay that is established on the tangible object; and
using the user's interaction with the virtual overlay as a basis for input to the processor based apparatus.

15. The system of claim 14, wherein the establishing a virtual overlay on the tangible object comprises automatically scaling the virtual overlay to fit the tangible object.

16. The system of claim 14, wherein the establishing a virtual overlay on the tangible object is performed in response to a command from the user.

17. The system of claim 16, wherein the command from the user comprises an audio command.

18. The system of claim 16, wherein the command from the user determines a configuration of the virtual overlay.

19. The system of claim 14, wherein the virtual overlay comprises a virtual user interface.

20. The system of claim 19, wherein the establishing a virtual overlay on the tangible object comprises mapping one or more tangible input mechanisms on the tangible object to one or more virtual input devices on the virtual user interface.

21. A non-transitory computer readable storage medium storing one or more computer programs configured to cause a processor based system to execute steps comprising:
identifying a tangible object;
establishing a virtual overlay on the tangible object in a manner that is visible to a user;
detecting the user's interaction with the virtual overlay that is established on the tangible object; and
using the user's interaction with the virtual overlay as a basis for input to the processor based system.

22. The non-transitory computer readable storage medium of claim 21, wherein the establishing a virtual overlay on the tangible object comprises automatically scaling the virtual overlay to fit the tangible object.

23. The non-transitory computer readable storage medium of claim 21, wherein the establishing a virtual overlay on the tangible object is performed in response to a command from the user.

24. The non-transitory computer readable storage medium of claim 23, wherein the command from the user comprises an audio command.

25. The non-transitory computer readable storage medium of claim 23, wherein the command from the user determines a configuration of the virtual overlay.
